(19) United States
(12) Patent Application Publication
(10) Pub. No.: US 2010/0325951 A1
(43) Pub. Date: Dec. 30, 2010

(54) Root Orb

(75) Inventor: Renee L. Molina, Miami, FL (US)

Correspondence Address: Renee L. Molina, 6121 SW 46, Terracer Maimi, FL, 33155, US

(73) Assignee: Renee Molina, Miami, FL (US)

(21) Appl. No.: 12/383,602

(22) Filed: Jun. 29, 2009

(51) Int. Cl. A01G 9/02

(52) U.S. Cl. 47/65.5

(57) ABSTRACT

Root Orb displays and contains a plant or plants in an Organic Moss

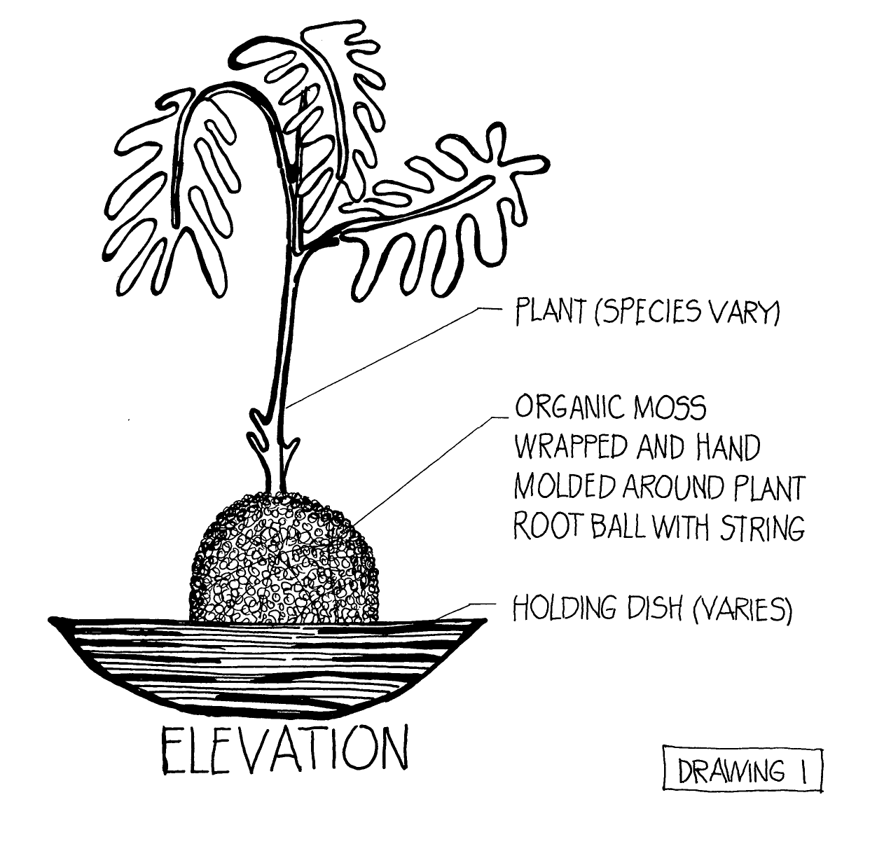

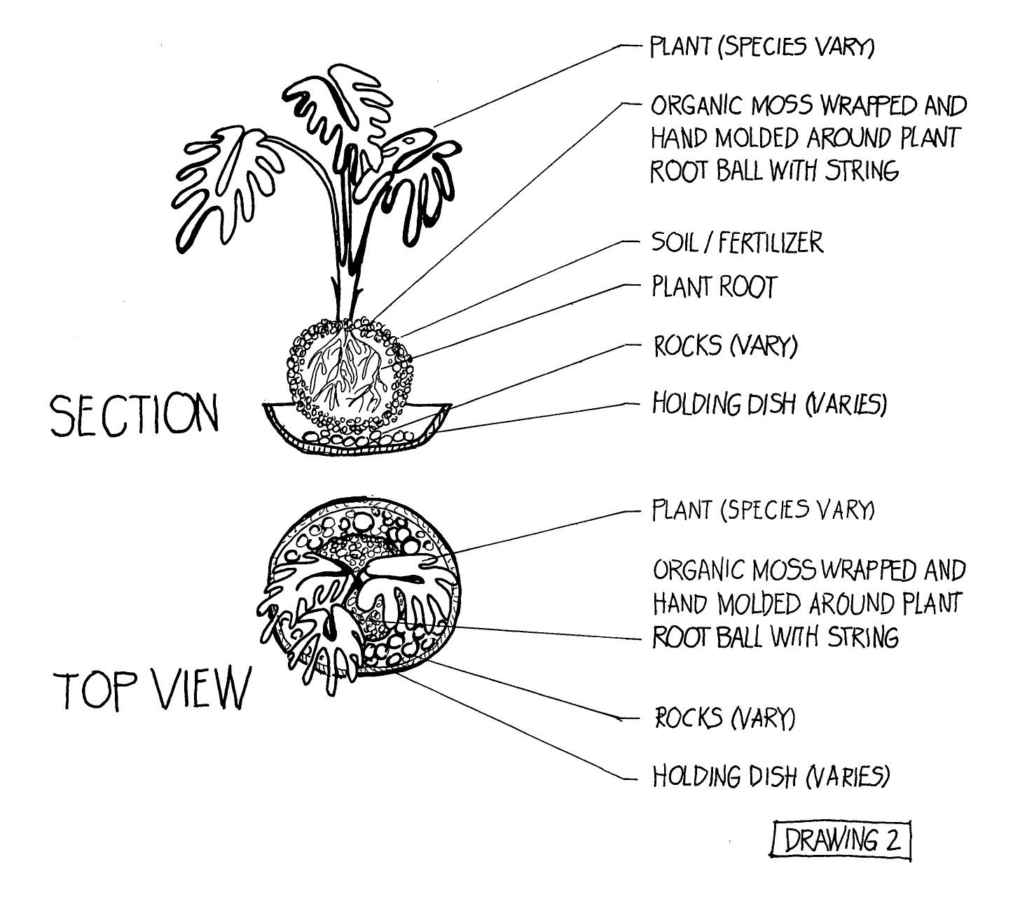

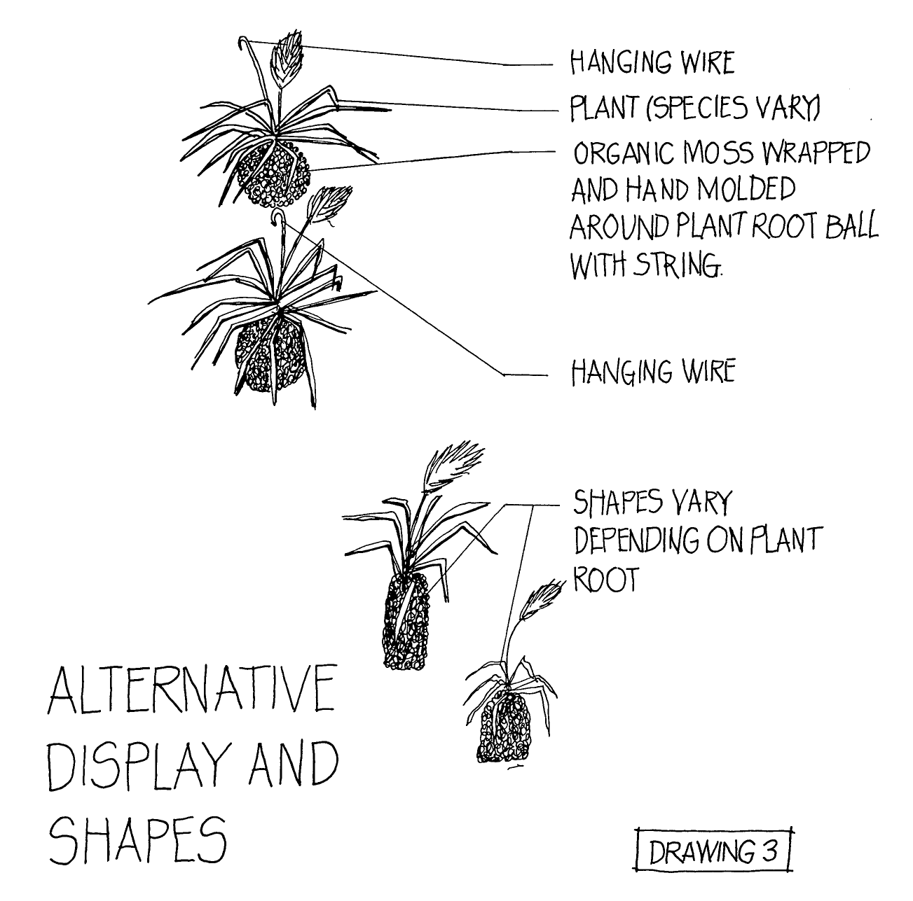

### MATERIALS

Moss: Organic Moss such as Chilean, Wisconsin sphagnum moss, or other types of organic moss.

Water: as cohesive agent for moss and as hydration agent for moss and plant.

String, cord, thread, filament, twine or any type of line is used to wrap moss around plant root.

plant: most type of plant species.

### EXECUTION

Moss: the dehydrated moss is combined with water.

The moss is hand pressed and molded onto plant root and shaped to desired form

As the moss is molded the process of wrapping it with string begins. The string wrapping is as uniform as possible to ensure moss stays in place. Final shape is derived by adding layers of moss until reaching desired size and shape.

This written description sets forth the a sample of the Root Orb invention and provides examples to describe the invention and to enable a person of ordinary skill to make a root orb. This written description does not limit the invention to the precise terms set forth. Thus, while the invention has been described in detail with reference to the examples set forth above, those of ordinary skill in the art may affect alterations, modifications and variations to the examples without departing from the scope of the invention.

### SUMMARY

The Root Orb was designed to keep plants healthy and beautiful. The Root Orb is an organic built in pot that is hand woven (see Drawing 1). The Root Orb takes the place of a traditional plant pot by wrapping (weaving) a plant's root ball in organic moss (Chilean, sphagnum or any type of organic moss) and String. This allows a unique visual display of any type of plant in many settings such as plates, baskets, drift wood and almost any other household accessory. Some of the plants assembled with root orb can also hang from galvanized bent wire or string.

The Root Orb serves the same function as a conventional plant pot but teaches the plant owner proper plant hydration by providing a visual cue as well as allowing the plant owner to feel when the Root Orb is dehydrated, suggesting the plant is ready for watering.

Watering of The Root Orb can be done outside or in a sink. The watering of the Root Orb is a simple process: immerse it in a container of water and then allow excess water to drain, and then return plant to its desired location. The Root Orb also helps avoid typical plant problems such as stagnant indoor water, over-hydration or under-hydration. The Root Orb can be applied to a variety of plants (drawing 1 and 3).

### BRIEF DESCRIPTION OF THE DRAWINGS

Drawing. 1 is an elevation diagram of a plant example displayed on a typical dish or plate tray. The plant species vary the drawing shows moss wrapped and hand molded around plant. The plant and moss are held with string.

Drawing. 2 is a sectional drawing and top view of a plant example.

Drawing. 3 is an image of an example alternative root orb shapes and manners in which to display. This drawing shows an example of hanging the Root Orb. The Root Orb can be hung with galvanized wire or string.

(replace the specification below)

Mar. 23, 2009

pplication Ser. No. 12/383,602

The Root Orb was designed to keep plants healthy and beautiful. It is an organic built- in pot (See Drawing 1). The Root Orb takes the place of a traditional plant pot by wrapping (weaving) a plant's root ball in organic moss (Chilean or Wisconsin Sphagnum) with string (monofilament or other types of string), see Drawing 2. This allows a unique visual display of any type of plant in many settings such as plates, baskets, drift wood, and household accessories, or just hanging from wire (see Drawings 1 and 3).

The Root Orb serves the same function as a conventional plant pot but teaches the plant owner proper plant hydration by providing visual and tactile cues for proper hydration. When Root Orb looks dry or feels dry to the tough, watering is needed. Watering of The Root Orb can be done outside or in a sink. The watering of the root orb is a simple process: immerse it in a container of water and then allow excess water to drain, and then return plant to its desired location. The Root Orb also helps avoid typical plant problems such as stagnant indoor water, over-hydration or under-hydration.

The Root Orb can be applied to a variety of plants (drawing 1 and 3).

1. The Root Orb was designed to keep plants healthy and beautiful. The Root Orb is made with organic medium which sustains plant life in a healthy manner and displays any type of plant species in a variety of manners.
